(19) United States
(12) Patent Application Publication
(10) Pub. No.: US 2004/0224234 A1
(43) Pub. Date: Nov. 11, 2004

(54) Wet-on-wet coating method for producing composite bodies that are suitable for use in lithium ion batteries

(76) Inventors: Stephan Bauer, Ostercappeln (DE); Bernd Bronstert, Otterstadt (DE); Helmut Mohwald, Annweiler (DE); Takeshi Tobinaga, Yokkaichi (JP)

Correspondence Address: KEIL & WEINKAUF, 1350 CONNECTICUT AVENUE, N.W., WASHINGTON, DC, 20036, US

(21) Appl. No.: 09/958,379

(22) PCT Filed: Apr. 7, 2001
(86) PCT No.: PCT/EP00/03131

(30) Foreign Application Priority Data
Apr. 9, 1999 (DE) 199 16 042.2

(51) Int. Cl. H01M 6/18

(52) U.S. Cl. 429/309

(57) ABSTRACT

The invention relates to a process for production of a composite article comprising:

A) at least one substrate film A and, applied thereto,

B) at least one separator layer B which comprises from 1 to 95% by weight of a solid and comprises no electron-conducting, electrochemically active compound, and

C) at least one negative-electrode layer C or

D) at least one positive-electrode layer D, or at least one negative-electrode layer C and at least one positive electrode layer D,

wherein the at least one separator layer B and the at least one negative-electrode layer C or the at least one positive-electrode layer D or the at least one negative-electrode layer C and the at least one positive-electrode layer D are brought into contact with one another by a wet-on-wet coating process.

The present invention relates to a special so-called wet-on-wet coating process for the production of composite articles which are suitable, inter alia, for electrochemical cells having electrolytes containing lithium ions, and to the use of the composite articles produced in this way, for example in or as lithium ion or other batteries, sensors, electrochromic windows, displays, capacitors and ion-conducting films.

Electrochemical, in particular rechargeable cells are known in general terms, for example from “Ullmann's Encyclopedia of Industrial Chemistry”, 5^{th} Edn., Vol. A3, VCH Verlagsgesellschaft mbH, Weinheim, 1985, pages 343-397.

Of these cells, lithium batteries and lithium ion batteries are of particular importance, in particular as secondary cells, owing to their high specific energy storage density.

The negative electrodes of cells of this type contain, as described, inter alia, in the above passage from “Ullmann”, lithiated manganese, cobalt, vanadium or nickel mixed oxides, as can be described, in the stoichiometrically simplest case, as LiMn₂O₄, LiCoO₂, LiV₂O₅ or LiNiO₂.

These mixed oxides react reversibly with compounds which can intercalate lithium ions into their lattice, for example graphite, with removal of lithium ions from the crystal lattice, in which the metal ions, such as manganese, cobalt or nickel ions, are oxidized. This reaction can be utilized in an electrochemical cell for current storage by separating the compound which intercalates the lithium ions, i.e. the positive-electrode material, and the lithium-containing mixed oxide, i.e. the negative-electrode material, by an electrolyte, through which the lithium ions migrate from the mixed oxide into the positive-electrode material (charging process).

The compounds which are suitable for reversible storage of lithium ions are usually fixed to collector electrodes by means of a binder.

During charging of the cell, electrons flow through an external voltage source and lithium cations flow through the electrolyte to the positive-electrode material. During use of the cell, the lithium cations flow through the electrolyte, whereas the electrons flow from the positive-electrode material to the negative-electrode material via a working resistance.

In order to avoid a short-circuit within the electro-chemical cell, a layer which is electrically insulating, but permeable to lithium cations is located between the two electrodes. This can be a so-called solid electrolyte or a conventional separator.

The production of composite articles of this type which are suitable for installation in a lithium ion battery, as described, for example, in U.S. Pat. No. 5,540,741 or U.S. Pat. No. 5,478,668, has hitherto been carried out virtually exclusively by conventional casting techniques, i.e. firstly a layer of the composite article is cast onto a substrate in the desired thickness and dried. After complete drying of this first layer, a further layer of the composite article is then applied, again dried, etc. The plasticizers used therein must subsequently be extracted, which means a further working step.

A process for the production of a mechanically stable composite article which is suitable, inter alia, for use in lithium ion batteries is described in WO 99/19917 by the present applicant. According to this application, the individual layers of the composite article are firstly cast, for example onto a temporary support film, and dried, if desired subjected to corona treatment and subsequently brought into contact with one another, for example by hot lamination. WO 98/44576 and DE-A 197 13 046 furthermore describe an extrusion process for the production of moldings for lithium ion batteries which comprises the steps of compounding and melt extrusion of the mixtures from which the individual layers of the composite article are obtained.

It is a primary object of the present invention to provide a further process for the production of mechanically stable composite articles which are suitable for use in lithium ion batteries which is simplified compared with the processes known from the prior art. In particular, additional steps, such as the extraction of plasticizers, and complex equipment should be unnecessary in a process of this type.

We have found that this and further objects are achieved by the process according to the present invention. Thus, the present invention relates to a process for the production of a composite article comprising

A) at least one substrate film A and, applied thereto,

B) at least one separator layer B which comprises a mixture I comprising a mixture II consisting of

a) from 1 to 95% by weight of a solid III, preferably a basic solid III, having a primary particle size of from 5 nm to 20 μm, and

b) from 5 to 99% by weight of a polymeric composition IV obtainable by polymerization of

b1) from 5 to 100% by weight, based on the composition IV, of a condensation product V of

α) at least one compound VI which is capable of reacting with a carboxylic acid or a sulfonic acid or a derivative or a mixture of two or more thereof, and

β) at least 1 mol per mole of the compound VI, of a carboxylic acid or sulfonic acid VII containing at least one free-radical-polymerizable functional group, or of a derivative thereof or of a mixture of two or more thereof, and

b2) from 0 to 95% by weight, based on the composition IV, of a further compound VIII having a mean molecular weight (number average) of at least 5000 containing polyether segments in the main or side chain,

where the proportion by weight of the mixture II in the mixture I is from 1 to 100% by weight, or

a polymer or copolymer of vinyl chloride, acrylonitrile, vinylidene fluoride, vinyl chloride with vinylidene chloride, vinyl chloride with acrylonitrile, vinylidene chloride with hexafluoropropylene, vinylidene fluoride with hexafluoropropylene and a member selected from the group consisting of vinyl fluoride, tetrafluoroethylene and a trifluoroethylene,

and where the layer comprises no electron-conducting, electrochemically active compound, and

C) at least one negative-electrode layer C which comprises an electron-conducting, electro-chemically active compound which is capable of releasing lithium ions during charging, or

D) at least one positive-electrode layer D which comprises an electron-conducting, electrochemical compound which is capable of taking up lithium ions during charging, or

at least one negative-electrode layer C and at least one positive-electrode layer D,

wherein the at least one separator layer B and the at least one negative-electrode layer C or the at least one positive-electrode layer D or the at least one negative-electrode layer C and the at least one positive-electrode layer D are brought into contact with one another by a wet-on-wet coating process.

The individual layers of the composite article produced in accordance with the invention are firstly described in detail below and the processing steps of the process according to the invention are subsequently discussed.

Substrate Film A

The substrate film A can in principle be any film which has sufficient mechanical stability to serve as substrate for the further layers of the composite article. Specific mention may be made of the following: temporary support films based on polyamide or polyester, for example nylon or PET; plastic-coated paper; polyolefin films; glass substrates, in particular ITO-coated glass substrates; films based on microporous polyethylene which are used in batteries, in general as conventional separators, and provide the battery with a so-called shut-down mechanism owing to their melting behavior. Such films are described, inter alia, in EP-A 0 715 364, EP-A 0 798 791 and DE-A 198 50 826. However, they are preferably films comprising at least one metal. This includes both metal-coated or metal vapour deposition-coated substrate films or metal foils per se, where metal foils typically used as collector electrodes are in turn preferred amongst the latter. Particularly preferred embodiments which may be mentioned individually are Cu foils as collector negative electrode and Al foils as collector positive electrode. The layer thickness of these foils is from 5 to 1000 μm, preferably from 5 to 100 μm, further preferably from 5 to 30 μm.

Separator Layer B

The term “solid III” covers all compounds which are solid under normal conditions and which, on operation of the battery, neither take up nor release electrons under the conditions prevailing during charging of batteries, in particular lithium ion batteries.

The solid III employed in this layer is primarily an inorganic solid, preferably an inorganic basic solid, selected from the group consisting of oxides, mixed oxides, silicates, sulfates, carbonates, phosphates, nitrides, amides, imides and carbides of the elements from main group I, II, III or IV or sub-group IV of the Periodic Table, a polymer selected from the group consisting of polyethylene, polypropylene, polystyrene, polytetrafluoroethylene, polyvinylidene fluoride, polyamides and polyimides; a solids dispersion comprising a polymer of this type; and a mixture of two or more thereof.

Particular mention may be made by way of example of the following: oxides, for example calcium oxide, silicon dioxide, aluminum oxide, magnesium oxide or titanium oxide, mixed oxides, for example of the elements silicon, calcium, aluminum, magnesium or titanium, silicates, for example ladder silicates, chain silicates, sheet silicates and framework silicates, preferably wollastonite, in particular hydrophobicized wollastonite, sulfates, for example alkali metal and alkaline earth metal sulfates; carbonates, for example alkali metal and alkaline earth metal carbonates, for example calcium carbonate, magnesium carbonate or barium carbonate, or lithium carbonate, potassium carbonate or sodium carbonate; phosphates, for example apatites; nitrides; amides; imides; carbides; polymers, for example polyethylene, polypropylene, polystyrene, polytetrafluoroethylene, polyvinylidene fluoride, polyamides or polyimides; or other thermoplastics, thermosets or microgels, solids dispersions, in particular those comprising the above-mentioned polymers, and mixtures of two or more of said solids.

The solid III employed in accordance with the invention may furthermore be an inorganic solid which conducts Li ions, preferably an inorganic basic solid which conducts Li ions.

The following may be mentioned here: lithium borates, for example Li₄B₆O₁₁*xH₂O, Li₃(BO₂)₃, Li₂B₄O₇*xH₂O, LiBO₂, where x can be a number from 0 to 20; lithium aluminates, for example Li₂O*Al₂O₃*H₂O, Li₂Al₂O₄, LiAlO₂; lithium aluminosilicates, for example lithium-containing zeolites, feldspars, feldspathoids, phyllosilicates and inosilicates, and in particular LiAlSi₂O₆ (spodumene), LiAlSi₄O₀O₁₀ (petullite), LiAlSiO₄ (eucryptite), mica, for example K[Li,Al]₃[AlSi]₄O₁₀(F—OH)₂, K[Li,Al,Fe]₃[AlSi]₄O₁₀(F—OH)₂; lithium zeolites, in particular those in fiber, sheet or tube form, in particular those having the general formula Li_{2/z}O*Al₂O₃*xSiO₂*yH₂O, where z corresponds to the valency, x is from 1.8 to about 12 and y is from 0 to about 8; lithium carbides, for example Li₂C₂ or Li₄C; Li₃N; lithium oxides and mixed oxides, for example LiAlO₂, Li₂MnO₃, Li₂O, Li₂O₂, Li₂MnO₄, Li₂TiO₃; Li₂NH; Li₂NH₂; lithium phosphates, for example Li₃PO₄, LiPO₃, LiAlFPO₄, LiAl(OH)PO₄, LiFePO₄, LiMnPO₄; Li₂CO₃; lithium silicates in ladder, chain, sheet and framework form, for example Li₂SiO₃, Li₂SiO₄ and Li₆Si₂; lithium sulfates, for example Li₂SO₄, LiHSO₄, LiKSO₄; and the Li compounds mentioned in the discussion of the negative-electrode layer, the presence of conductive black being excluded if it is used as solid III; and mixtures of two or more of the abovementioned Li ion-conducting solids.

Particularly suitable here are basic solids. For the purposes of the present invention, the term basic solids is taken to mean those whose mixture with a liquid, water-containing diluent which itself has a maximum pH of 7 has a higher pH than this diluent.

The solids should advantageously be substantially insoluble in the liquid used as electrolyte and should be electrochemically inert in the battery medium.

Particularly suitable solids are those which have a primary particle size of from 5 nm to 20 μm, preferably from 0.01 to 10 μm, in particular from 0.1 to 5 μm, the stated particle sizes being determined by electron microscopy. The melting point of the pigments is preferably above the usual operating temperature of electrochemical cells, a melting point of above 120° C., in particular above 150° C., having proven particularly suitable.

The solids here can be symmetrical with respect to their external shape, i.e. have a height width length size ratio (aspect ratio) of approximately 1 and be in the form of beads, granules, approximately round structures, but also in the form of any desired polyhedra, for example as cuboids, tetrahedra, hexahedra, octahedra or as bipyramids, or can be distorted or asymmetric, i.e. have a height:width:length size ratio (aspect ratio) which is not equal to 1 and be in the form, for example, of needles, asymmetric tetrahedra, asymmetric bipyramids, asymmetric hexahedra or octahedra, platelets, disks or fibrous structures. If the solids are in the form of asymmetrical particles, the abovementioned upper limit for the primary particle size relates to the smallest axis in each case.

The compound VI which is capable of reacting with a carboxylic acid or a sulfonic acid VII or a derivative or mixture of two or more thereof can in principle be any compound which satisfies this criterion.

The compound VI is preferably selected from the group consisting of monohydric and polyhydric alcohols containing exclusively carbon atoms in the main chain; monohydric and polyhydric alcohols containing at least one atom selected from the group consisting of oxygen, phosphorus and nitrogen in the main chain in addition to at least two carbon atoms; silicon-containing compounds; amines containing at least one primary amino group; amines containing at least one secondary amino group; aminoalcohols; thiols containing one or more thiol groups; compounds containing at least one thiol group and at least one hydroxyl group; and a mixture of two or more thereof.

Of these, preference is in turn given to compounds VI containing two or more functional groups which are capable of reacting with the carboxylic acid or sulfonic acid.

If use is made of compounds VI containing amino groups as functional group, it is preferred to use those containing secondary amino groups, so that, after the condensation, either no free NH groups, or only a small amount of free NH groups, are present in the mixture Ia.

Preferred compounds which may be mentioned in detail are the following:

monohydric and polyhydric alcohols containing exclusively carbon atoms in the main chain, having 1 to 20, preferably 2 to 20, in particular 2 to 10, alcholic OH groups, in particular dihydric, trihydric and tetrahydric alcohols, preferably having 2 to 20 carbon atoms, for example ethylene glycol, 1,2- and 1,3-propanediol, 1,2- and 1,3-butanediol, 1,4-butenediol, 1,4-butynediol, 1,6-hexanediol, neopentyl glycol, 1,2-dodecanediol, glycerol, trimethylolpropane, pentaerythritol and sugar alcohols, hydroquinone, novolak, bisphenol A, but it is also possible, as evident from the above definition, to employ monohydric alcohols, for example methanol, ethanol, propanol, n-, sec- or tert-butanol; it is furthermore also possible to use polyhydroxyolefins, preferably those having two terminal hydroxyl groups, for example α,ω-di-hydroxybutadiene;

polyester polyols, as disclosed, for example, in Ullmann's Enzyklopädie der technischen Chemie [Ullmann's Encyclopedia of Industrial Chemistry], 4^{th} Edition, Vol. 19, pp. 62-65, which are obtained, for example, by reacting dihydric alcohols with polybasic, preferably dibasic polycarboxylic acids;

monohydric and polyhydric alcohols containing at least one oxygen atom in the main chain in addition to at least two carbon atoms, preferably polyether alcohols, for example products of the polymerization of alkylene epoxides, preferably isobutylene oxide, propylene oxide, ethylene oxide, 1,2-epoxybutane, 1,2-epoxy-pentane, 1,2-epoxyhexane, tetrahydrofuran, styrene oxide, where polyether alcohols modified at the terminal groups, for example polyether alcohols modified by means of NH₂ terminal groups, can also be used; these alcohols preferably have a molecular weight (number average) of from 100 to 5000, further preferably from 200 to 1000, in particular from 300 to 800; such compounds are known per se and are commercially available under the trade names Pluriol® or Pluronic® (BASF Aktiengesellschaft);

alcohols as defined above in which some or all of the carbon atoms have been replaced by silicon, where in particular polysiloxanes or alkylene oxide-siloxane copolymers or mixtures of polyether alcohols and polysiloxanes, as described, for example, in EP-B 581 296 and EP-A 525 728, can be used here, the comments made above regarding the molecular weight of these alcohols likewise applying here;

alcohols as defined above, in particular polyether alcohols, in which some or all of the oxygen atoms have been replaced by sulfur atoms, the comments made above regarding the molecular weight of these alcohols likewise applying here;

monohydric and polyhydric alcohols containing at least one phosphorus atom or at least one nitrogen atoms in the main chain in addition to at least two carbon atoms, for example diethanolamine and triethanolamine;

lactones derived from compounds of the general formula HO—(CH₂)ₙ—COOH, where z is a number from 1 to 20, for example ε-caprolactone, β-propiolactone, γ-butyrolactone or methyl-ε-caprolactone;

silicon-containing compounds, for example di- and trichlorosilane, phenyltrichlorosilane, diphenyldichlorosilane and dimethylvinylchlorosilane; silanols, for example trimethylsilanol;

amines containing at least one primary and/or secondary amino group, for example butylamine, 2-ethylhexylamine, ethylenediamine, hexamethylenediamine, diethylenetriamine, tetraethylenepentamine, pentaethylenehexamine, aniline and phenylenediamine;

polyetherdiamines, for example 4,7-dioxydecane-1,10-diamine and 4,11-dioxytetradecane-1,14-diamine;

thiols containing one or more thiol groups, for example aliphatic thiols, such as methanethiol, ethanethiol, cyclohexanethiol and dodecanethiol; aromatic thiols, for example thiophenol, 4-chlorothiophenol and 2-mercaptoaniline;

compounds containing at least one thiol group and at least one hydroxyl group, for example 4-hydroxy-thiophenol and monothio derivatives of the polyhydric alcohols defined above;

aminoalcohols, for example ethanolamine, N-methylethanolamine, N-ethylethanolamine, N-butylethanolamine, 2-amino-1-propanol and 2-amino-1-phenylethanol, mono- and polyaminopolyols containing more than two aliphatically bound hydroxyl groups, for example tris(hydroxymethyl)methylamine, glucamine and N,N′-bis(2-hydroxyethyl)ethylenediamine.

It is also possible to employ mixtures of two or more of the compounds VI described above.

The abovementioned compounds VI are condensed according to the invention with a carboxylic acid or sulfonic acid VII containing at least one free-radical-polymerizable functional group, or a derivative thereof or a mixture of two or more thereof, where at least one, preferably all, of the free condensation-capable groups within the compounds VI are condensed with the compound VII.

For the purposes of the present invention, the carboxylic acid or sulfonic acid VII can in principle be any carboxylic or sulfonic acid containing at least one free-radical-polymerizable functional group, and derivatives thereof. The term “derivatives” used here covers both compounds derived from a carboxylic or sulfonic acid which has been modified on the acid function, for example esters, acid halides and acid anhydrides, and compounds derived from a carboxylic or sulfonic acid which has been modified on the carbon skeleton of the carboxylic or sulfonic acid, for example halocarboxylic or halosulfonic acids.

The following may be mentioned in particular as compound VII:

α,β-unsaturated carboxylic acids or β,γ-unsaturated carboxylic acids.

Particularly suitable α,β-unsaturated carboxylic acids are those of the formula

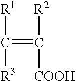

in which R¹, R² and R³ are hydrogen or C₁- to C₄-alkyl radicals, where of these acrylic acid and methacrylic acid are in turn preferred; also highly suitable are cinnamic acid, maleic acid, fumaric acid, itaconic acid and p-vinylbenzoic acid, and derivatives thereof, for example anhydrides, for example maleic anhydride and itaconic anhydride;

halides, in particular chlorides, for example acryloyl and methacryloyl chloride;

esters, for example (cyclo)alkyl (meth)acrylates having up to 20 carbon atoms in the alkyl radical, for example methyl, ethyl, propyl, butyl, hexyl, 2-ethylhexyl, stearyl, lauryl, cyclohexyl, benzyl, trifluoromethyl, hexafluoropropyl and tetrafluoropropyl (meth)acrylate, polypropylene glycol mono(meth)acrylates, polyethylene glycol mono(meth)acrylates, poly(meth)acrylates of polyhydric alcohols, for example glycerol di(meth)acrylate, trimethylolpropane di(meth)acrylate, pentaerythritol di- or tri(meth)acrylate, diethylene glycol bis(mono-(2-acryloxy)ethyl)carbonate, poly(meth)acrylates of alcohols which themselves in turn contain a free-radical-polymerizable group, for example esters of (meth)acrylic acid and vinyl and/or allyl alcohol;

vinyl esters of other aliphatic or aromatic carboxylic acids, for example vinyl acetate, vinyl propionate, vinyl butyrate, vinyl hexanoate, vinyl octanoate, vinyl decanoate, vinyl stearate, vinyl palmitate, vinyl crotonate, divinyl adipate, divinyl sebacate, vinyl 2-ethylhexanoate and vinyl trifluoroacetate;

allyl esters of other aliphatic or aromatic carboxylic acids, for example allyl acetate, allyl propionate, allyl butyrate, allyl hexanoate, allyl octanoate, allyl decanoate, allyl stearate, allyl palmitate, allyl crotonate, allyl salicylate, allyl lactate, diallyl oxalate, diallyl malonate, diallyl succinate, diallyl glutarate, diallyl adipate, diallyl pimelate, diallyl cinnatricarboxylate, allyl trifluoroacetate, allyl perfluorobutyrate and allyl perfluorooctanoate;

β,γ-unsaturated carboxylic acids and their derivatives, for example vinylacetic acid, 2-methylvinylacetic acid, isobutyl 3-butenoate, allyl 3-butenoate, allyl 2-hydroxy-3-butenoate and diketene;

sulfonic acids, for example vinylsulfonic acid, allyl- and methallylsulfonic acid, and esters and halides thereof, vinyl benzenesulfonate and 4-vinylbenzenesulfonamide.

It is also possible to employ mixtures of two or more of the carboxylic and/or sulfonic acids described above.

In one embodiment, the separator layer B thus preferably comprises a mixture I comprising a mixture II consisting of

a) from 1 to 95% by weight of a solid III, preferably a basic solid III, having a primary particle size of from 5 nm to 20 μm, and

b) from 5 to 99% by weight of a polymeric composition IV obtainable by polymerization of

b1) from 5 to 100% by weight, based on the composition IV, of a condensation product V of

α) a polyhydric alcohol VI which contains carbon and oxygen atoms in the main chain, and

β) at least 1 mol per mole of the polyhydric alcohol VI of an α,β-unsaturated carboxylic acid VII and

b2) from 0 to 95% by weight, based on the composition IV, of a further compound VIII having a mean molecular weight (number average) of at least 5000 containing polyether segments in the main or side chain,

where the proportion by weight of the mixture II in the mixture I is from 1 to 100% by weight.

Suitable compounds VIII are primarily compounds having a mean molecular weight (number average) of at least 5000, preferably from 5000 to 20,000,000, in particular from 100,000 to 6,000,000, which are capable of solvating lithium cations and functioning as binders. Suitable compounds VIII are, for example, polyethers and copolymers containing at least 30% by weight of the following structural unit, based on the total weight of the compound VIII:

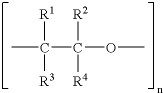

where R¹, R², R³ and R⁴ can be aryl groups, alkyl groups, preferably methyl groups, or hydrogen, may be identical or different and may contain heteroatoms, such as oxygen, nitrogen, sulfur or silicon.

Such compounds are described, for example, in: M. B. Armand et al., Fast Ion Transport in Solids, Elsevier, New York, 1979, pp. 131-136, or in FR-A 7832976.

The compound VIII can also consist of mixtures of two or more of such compounds.

The mixtures II should consist, in accordance with the invention, of from 1 to 95% by weight, preferably from 25 to 90% by weight, in particular from 30 to 70% by weight, of a solid III and from 5 to 99% by weight, preferably from 10 to 75% by weight, in particular from 30 to 70% by weight, of a polymeric composition IV, where the compound VIII in the polymeric composition IV should advantageously have a mean molecular weight (number average) of from 5,000 to 100,000,000, preferably from 50,000 to 8,000,000. The polymeric composition IV can be obtained by reacting from 5 to 100% by weight, preferably from 30 to 70% by weight, based on the polymeric composition IV, of a compound V and from 0 to 95% by weight, in particular from 30 to 70% by weight, based on the polymeric composition IV, of a compound VIII.

In order to prepare the mixture used in accordance with the invention, which should comprise a mixture used in accordance with the invention in amounts of from 1 to 100% by weight, preferably from 35 to 100% by weight, in particular from 30 to 70% by weight, based on the mixture used in accordance with the invention, a mixture of a solid III, a condensation product V, if desired a compound VIII and conventional additives, for example plasticizers, preferably plasticizers containing polyethylene oxide or polypropylene oxide, can be prepared.

In a further embodiment, the separator layer B comprises polymers and copolymers of vinyl chloride, acrylonitrile, vinylidene fluoride, vinyl chloride with vinylidene chloride, vinyl chloride with acrylonitrile, vinylidene chloride with hexafluoropropylene, vinylidene fluoride with hexafluoropropylene and a member selected from the group consisting of vinyl fluoride, tetrafluoroethylene and a trifluoroethylene, as described, for example, in U.S. Pat. No. 5,540,741 and U.S. Pat. No. 5,478,668, the disclosure content of which in this respect is incorporated into the context of the present application in its full extent. Of these, preference is in turn given to copolymers of vinylidene fluoride (1,1-difluoroethene) and hexafluoropropene, further preferably random copolymers of vinylidene chloride and hexafluoropropene, where the proportion by weight of the vinylidene fluoride is from 75 to 92% and that of the hexafluoropropene is from 8 to 25%.

These polymers and also the condensation products V are polymerized in a conventional manner which is well known to the person skilled in the art, preferably by means of free radicals, where the above-said regarding the compound VIII applies with respect to the molecular weights obtained.

The thickness of the separator layer B is generally from 5 to 100 μm, in particular from 10 to 50 μm.

Positive-Electrode Layer C and Negative-Electrode Layer D

The polymeric binder within these layers C and D can be any known polymer which is electrochemically, mechanically and thermally stable under the operating conditions of batteries and has an adequate binder action. The polymeric binders employed in layers C and D can be identical to or different from one another.

Particular mention may be made of the following:

1) Homopolymers, block polymers or copolymers IV obtainable by polymerization of the mixtures I defined above,

2) Homopolymers, block polymers and copolymers prepared from

halogen-containing olefinic compounds, such as vinyl chloride, vinyl fluoride, vinylidene fluoride, vinylidene chloride, hexafluoropropene, trifluoropropene, 1,2-dichloroethene, 1,2-difluoroethene and tetrafluoroethene.

Of these, preference is given to random copolymers of vinylidene fluoride and hexafluoropropylene, in particular those which have a content of hexafluoropropene of from 8 to 25% by weight and a content of vinylidene fluoride of from 75 to 92% by weight, in each case based on the total weight of the copolymer.

3) In addition, conventional laminar negative electrodes and positive electrodes, as listed, for example, in the examples, can also be employed.

The negative-electrode layer C comprises an electron-conducting, electrochemically active compound (negative-electrode compound) conventionally used for negative electrodes which is capable of taking up electrons during charging, preferably a lithium compound. Particular mention should be made of the following:

LiCoO₂, LiNiO₂, LiNiₓCo_{y}O₂, LiNiₓCo_{y}Al_{z}O₂, with 0<x,y,z≦1, LiₓMnO₂ (0<x≦1), LiₓMn₂O₄ (0<x≦2), LiₓMoO₂ (0<x≦2), LiₓMnO₃ (0<x≦1), LiₓMnO₂ (0<x≦2), LiₓMn₂O₄ (0<x≦2), LiₓV₂O₄ (0<x≦2.5), LiₓV₂O₃ (0<x≦3.5), LiₓVO₂ (0<x≦1), LiₓWO₂ (0<x≦1), LiₓWO₃ (0<x≦1), LiₓTiO₂ (0<x≦1), LiₓTi₂O₄ (0<x≦2), LiₓRuO₂ (0<x≦1), LiₓFe₂O₃ (0<x≦2), LiₓFe₃O₄ (0<x≦2), LiₓCr₂O₃ (0<x≦3), LiₓCr₃O₄ (0<x≦3.8), LiₓV₃S₅ (0<x≦1.8), LiₓTa₂S₂ (0<x≦1), LiₓFeS (0<x≦1), LiₓFeS₂ (0<x≦1), LiₓNbS₂ (0<x≦2.4), LiₓMoS₂ (0<x≦3), LiₓTiS₂ (0<x≦2), LiₓZrS₂ (0<x≦2), LiₓNbSe₂ (0<x≦3), LiₓVSe₂ (0<x≦1), LiₓNiPS₂ (0<x≦1.5) and LiₓFePS₂ (0<x≦1.5).

The positive-electrode layer D comprises an electron-conducting, electrochemically active compound (positive-electrode compound) known from the prior art which is capable of releasing electrons during charging, preferably a lithium compound. Particular mention should be made of the following:

lithium, lithium-containing metal alloys, micronized carbon black, natural and synthetic graphite, synthetically graphitized coaldust and carbon fibers, oxides, such as titanium oxide, zinc oxide, tin oxide, molybdenum oxide and tungsten oxide, and carbonates, such as titanium carbonate, molybdenum carbonate and zinc carbonate.

The positive-electrode layer D furthermore comprises up to 30% by weight, based on the total weight of the materials making it up (polymeric binder plus positive-electrode compound), of conductive black and, if desired, conventional additives. The negative-electrode layer C comprises, based on the total weight of the materials making it up (polymeric binder plus negative-electrode compound), from 0.1 to 20% by weight of conductive black.

Adhesion-Promoting Layer E

The adhesion-promoting layer E can in principle be any material which is capable of bonding the at least one first layer, as defined above, and the at least one second layer, as defined above, to one another, for example hot-melt adhesives, heat-sealing adhesives, contact adhesives, pressure-sensitive adhesives, pressure-sensitive emulsion adhesives and epoxy adhesives.

Further details with respect to the materials which can be used in accordance with the invention in the adhesion-promoting layer are revealed by an article with the title “Kleben und Klebestoffe” [Adhesion and Adhesives] (Chemie in unserer Zeit, issue 4 (1980)), and Ullmann, Enzyklopädie der technischen Chemie [Encyclopaedia of Industrial Chemistry], 4th Edition (1977), Vol. 14, pp. 227-268, and the reference PCT/EP98/06394 cited therein, which can be incorporated into the context of the present application with respect to the materials having adhesive properties described therein.

As already stated in the introduction, the process according to the invention comprises bringing the layers defined herein into contact with one another by a so-called wet-on-wet coating process. The principles of a process of this type are described in EP-B 0 520 155, in particular on page 34, which is incorporated into the context of the present application in its full extent. In the wet-on-wet coating process, the layers required are applied to one another with high efficiency. “Wet-on-wet” here means that after application of, for example, the positive-electrode layer D to, for example, a collector positive electrode, the separator layer B is applied at a point in time before the positive-electrode layer is completely dry.

The individual layers are applied here using conventional coating devices, for example a roll coater, a knife coater or an extrusion coater. Furthermore, the two layers can also be applied virtually simultaneously using a single coating head having two outlets or an extrusion coater having a back-up roll. Such devices are likewise described in detail in the reference cited in EP-B 0 520 155 at the point indicated.

In order to prevent agglomeration of the solid or of the negative-electrode and positive-electrode compounds present in the negative-electrode and positive-electrode layers respectively, the composition to be applied is preferably subjected to shear forces within the coating device or coating heads. The term “wet state” in the context of the present application means that the applied composition still feels tacky when touched with the hand or adheres to the hand. In this so-called “wet state”, the applied composition generally still contains from 5 to 10% of the solvent added thereto before the coating.

The present invention relates in particular to a process for the production of composite articles which have the following structure:

collector negative electrode

a negative-electrode layer C,

a separator layer B,

a positive-electrode layer D, and

collector positive electrode.

In a further embodiment of the present invention, the separator layer B, the negative-electrode layer C and the positive-electrode layer D each comprise the above-defined copolymer having a content of hexafluoropropene of from 8 to 25% by weight, based on the total weight of the copolymer.

The composite articles according to the invention may additionally contain a plasticizer. Suitable plasticizers of this type are described in WO 99/19917 and WO 99/18625.

The plasticizers used are preferably dimethyl carbonate, diethyl carbonate, dipropyl carbonate, diisopropyl carbonate, dibutyl carbonate, ethylene carbonate and propylene carbonate; ethers, for example dibutyl ether, di-tert-butyl ether, dipentyl ether, dihexyl ether, diheptyl ether, dioctyl ether, dinonyl ether, didecyl ether, didodecyl ether, ethylene glycol dimethyl ether, ethylene glycol diethyl ether, 1-tert-butoxy-2-methoxyethane, 1-tert-butoxy-2-ethoxyethane, 1,2-dimethoxypropane, 2-methoxyethyl ether and 2-ethoxyethyl ether; oligoalkylene oxide ethers, for example diethylene glycol dibutyl ether, dimethylene glycol tert-butyl methyl ether, triethylene glycol dimethyl ether, tetraethylene glycol dimethyl ether, γ-butyrolactone and dimethylformamide; hydrocarbons of the general formula CnH₂ₙ₊₂, where 7<n<50; organophosphorus compounds, in particular phosphates and phosphonates, for example trimethyl phosphate, triethyl phosphate, tripropyl phosphate, tributyl phosphate, triisobutyl phosphate, tripentyl phosphate, trihexyl phosphate, trioctyl phosphate, tris(2-ethylhexyl) phosphate, tridecyl phosphate, diethyl-n-butyl phosphate, tris(butoxyethyl) phosphate, tris(2-methoxyethyl) phosphate, tris(tetrahydrofuryl) phosphate, tris(1H, 1H,5H-octafluoropentyl) phosphate, tris(1H,1H-trifluoroethyl) phosphate, tris(2-(diethylamino)ethyl)phosphate, diethyl ethylphosphonate, dipropyl propylphosphonate, dibutyl butylphosphonate, dihexyl hexylphosphonate, dioctyl octylphosphonate, ethyl dimethyl phosphonoacetate, methyl diethyl phosphonoacetate, triethyl phosphonoacetate, dimethyl 2-hydroxypropylphosphonate, diethyl 2-hydroxypropylphosphonate, dipropyl 2-hydroxypropylphosphonate, ethyl diethoxyphosphinylformate, trimethyl phosphonoacetate, triethyl phosphonoacetate, tripropyl phosphonoacetate and tributyl phosphonoacetate. Preference is given to trialkyl phosphates and carbonates.

The proportion of plasticizers in the respective layer, based on the mixture present therein or the material constituting the layer (polymeric binder plus negative and positive electrode materials), is from 0 to 200% by weight, preferably from 0 to 100% by weight, further preferably from 0 to 70% by weight.

The starting materials used for the respective layer can be dissolved or dispersed in an inorganic, preferably an organic, liquid diluent, where the resultant solution should preferably have a viscosity of from 100 to 50,000 mPas, and can, if desired, subsequently be applied to a support material in a manner known per se, such as spray coating, pouring, dipping, spin coating, roller coating, letterpress printing, intaglio printing, planographic printing or screen printing, or alternatively by extrusion, i.e. shaped to give a sheet-like structure. The further processing can be carried out in the usual manner, for example by removal of diluent and curing of the mixture.

Suitable organic diluents are aliphatic ethers, in particular tetrahydrofuran and dioxane, hydrocarbons, in particular hydrocarbon mixtures, such as benzine, toluene and xylene, aliphatic esters, in particular ethyl acetate and butyl acetate, and ketones, in particular acetone, ethyl methyl ketone and cyclohexanone. It is also possible to employ combinations of such diluents.

After film formation, volatile components, such as solvents or plasticizers, can be removed.

If crosslinking of the layers is desired, it can be carried out in a manner known per se, for example by irradiation with ionic or ionizing radiation, electron beams, preferably with an acceleration voltage of between 20 and 2000 kV and a radiation dose of between 5 and 50 Mrad, UV or visible light, it being advantageous to add an initiator, such as benzyl dimethyl ketal or 1,3,5-trimethylbenzoyltriphenylphosphine oxide, in a conventional manner in maximum amounts of, in particular, 1% by weight, based on the components to be crosslinked, to the starting materials, and to carry out the crosslinking within, in general, from 0.5 to 15 minutes under an inert gas, such as nitrogen or argon; by thermal free-radical polymerization, preferably at temperatures of above 60° C., in which case an initiator, such as azobisisobutyronitrile, may advantageously be added in maximum amounts of, in general, 5% by weight, preferably from 0.05 to 1% by weight, based on the components to be crosslinked, to the starting materials; by electrochemically induced polymerization; or by ionic polymerization, for example by acid-catalyzed cationic polymerization, where suitable catalysts are primarily acids, preferably Lewis acids, such as BF₃, or in particular LiBF₄ or LiPF₆. Catalysts containing lithium ions, such as LiBF₄ and LiPF₆, can advantageously remain in the solid electrolyte or separator as conductive salt.

Furthermore, the layers described herein can contain a lithium cation-containing compound which is capable of dissociation, a so-called conductive salt, and, if desired, further additives, such as, in particular, organic solvents, a so-called electrolyte.

Some or all of these substances are admixed with the mixture during production of the layer or introduced into the layer after its production.

Conductive salts which can be used are the generally known conductive salts described, for example, in EP-A 0 096 629. The conductive salt preferably employed according to the invention is LiPF₆, LiBF₄, LiClO₄, LiAsF₆, LiCF₃SO₃, LiC(CF₃SO₂) 3, LiN(CF₃SO₂)₂, LiN(SO₂CnF₂+₁)₂, LiC[(CnF₂ₙ₊₁)SO₂]3, Li(CnF₂ₙ₊₁)SO₃, where n is in each case from 2 to 20, LiN(SO₂F)₂, LiAlCl₄, LiSiF₆, LiSbF₆, or a mixture of two or more thereof, where the conductive salt employed is preferably LiBF₄ or LiPF₆.

These conductive salts are employed in amounts of from 0.1 to 50% by weight, preferably from 0.1 to 20% by weight, in particular from 1 to 10% by weight, in each case based on the material forming the respective layer.

The layers forming the composite articles according to the invention generally have a thickness of from 5 to 500 μm, preferably from 10 to 500 μm, further preferably from 10 to 200 μm. The composite article, preferably in the form of a film, generally has a total thickness of from 15 to 1500 μm, in particular of from 50 to 500 μm.

The present invention furthermore relates to the use of a composite article, as defined above, for the production of an electrochemical cell, in a sensor, an electrochromic window, a display, a capacitor or an ion-conducting film.

It furthermore relates to an electrochromic cell comprising a composite article according to the invention or a combination of two or more thereof.

Suitable organic electrolytes here are the compounds discussed above under “plasticizers”, preference being given to the conventional organic electrolytes, preferably esters, such as ethylene carbonate, propylene carbonate, dimethyl carbonate and diethyl carbonate, or mixtures of these compounds.

The filling of composite elements of this type with an electrolyte and conductive salt can be carried out either before combination or preferably after combination of the layers, if desired after contacting with suitable collector electrodes, for example a metal foil, and even after introduction of the composite element into a battery casing, where the special microporous structure of the layers enables take-up of the electrolyte and conductive salt and expulsion of the air in the pores when the mixture according to the invention is used, in particular due to the presence of the solid defined above in the respective layers. The filling can be carried out at temperatures of from 0° C. to approximately 100° C., depending on the electrolyte used. The filling with the electrolyte and the conductive salt is preferably carried out after the composite article has been introduced into the battery casing.

The electrochemical cells according to the invention can be used, in particular, as automotive batteries, portable batteries, flat batteries, on-board batteries, batteries for static applications, batteries for electric traction or polymer batteries.

Compared with the previous processes for the production of composite articles of this type or solid electrolytes/separators, the process claimed herein has, in particular, the following advantages:

In the wet-on-wet coating process used here, the individual layers can be applied shortly after one another or even simultaneously; this is thus an extremely effective process for the production of composite articles of this type.

Due to the fact that the layers in question are already applied to a mechanically stable substrate film, it is not necessary for the layers themselves to be mechanically stable.

In order to obtain a mechanically stable composite article, it is not necessary to carry out a lamination step in the present invention.

The process according to the invention can be carried out using conventional coating devices.

On use of, in particular, the trialkyl phosphates and carbonates explicitly mentioned as plasticizers, it is furthermore unnecessary to carry out an extraction step after the production of the individual layers or of the composite article.

### EXAMPLES

### Example 1

A suspension consisting of

| | |
|---|---|
| 35 g | of Kynarflex ® 2801 |
| 50 g | of wollastonite Tremin ® 800 EST |
| 15 g | of tris(2-ethylhexyl) phosphate |
| 200 g | of toluene |

was applied to a still incompletely dried electrode consisting of a copper foil (15 μm) which had been coated with a suspension consisting of

| | |
|---|---|
| 200 g | of MCMB graphite |
| 10 g | of conductive black |
| 6 g | of PVDF |
| 250 g | of NMP. |

The electrode was subsequently dried at elevated temperatures (from about 50 to 150° C.) and reduced pressure.

### Example 2

Firstly, an electrode consisting of:

| | |
|---|---|
| 5600 g | of MCMB graphite (Osaka Gas) |
| 1500 g | of Kynar ® 2801 (Elf Atochem) |
| 400 g | of conductive black Super ® P (MMM Carbon) |
| 5000 g | of propylene carbonate |

and immediately thereafter a separator consisting of

| | |
|---|---|
| 3000 g | of Kynar ® 2801 |
| 2000 g | of Aerosil ® 8200 (Degussa) |
| 5000 g | of propylene carbonate |

were co-extruded onto a copper foil (15 μm) using two twin-screw extruder units and a chill-roll unit. The internal temperature in the extruder and in the flat-film die was from about 130 to 150° C. The highly adhesive composite consisting of copper foil, electrode and separator had a film thickness of from 250 to 300 μm.

We claim:

1. A process for the production of a composite article comprising
A) at least one substrate film A and, applied thereto,
B) at least one separator layer B which comprises a mixture I comprising a mixture II consisting of
a) from 1 to 95% by weight of a solid III, preferably a basic solid III, having a primary particle size of from 5 nm to 20 μm, and
b) from 5 to 99% by weight of a polymeric composition IV obtainable by polymerization of
b1) from 5 to 100% by weight, based on the composition IV, of a condensation product V of
α) at least one compound VI which is capable of reacting with a carboxylic acid or a sulfonic acid or a derivative or a mixture of two or more thereof, and
β) at least 1 mol per mole of the compound VI, of a carboxylic acid or sulfonic acid VII containing at least one free-radical-polymerizable functional group, or of a derivative thereof or of a mixture of two or more thereof, and
b2) from 0 to 95% by weight, based on the composition IV, of a further compound VIII having a mean molecular weight (number average) of at least 5000 containing polyether segments in the main or side chain,
where the proportion by weight of the mixture II in the mixture I is from 1 to 100% by weight, or
a polymer or copolymer of vinyl chloride, acrylonitrile, vinylidene fluoride, vinyl chloride with vinylidene chloride, vinyl chloride with acrylonitrile, vinylidene chloride with hexafluoropropylene, vinylidene fluoride with hexafluoropropylene and a member selected from the group consisting of vinyl fluoride, tetrafluoroethylene and a trifluoroethylene,
and where the layer comprises no electron-conducting, electrochemically active compound, and
C) at least one negative-electrode layer C which comprises an electron-conducting, electrochemically active compound which is capable of releasing lithium ions during charging, or
D) at least one positive-electrode layer D which comprises an electron-conducting, electrochemical compound which is capable of taking up lithium ions during charging, or
at least one negative-electrode layer C and at least one positive-electrode layer D,
wherein the at least one separator layer B and the at least one negative-electrode layer C or the at least one positive-electrode layer D or the at least one negative-electrode layer C and the at least one positive-electrode layer D are brought into contact with one another by a wet-on-wet coating process.

2. A process as claimed in claim 1, where the composite article furthermore comprises at least one adhesion-promoting layer E.

3. A process as claimed in claim 1 or 2, where the at least one substrate film A is a film-form collector electrode.

4. A process as claimed in any one of claims 1 to 3, where the at least one separator layer B comprises a random copolymer of vinylidene fluoride and hexafluoropropene having a content of hexafluoropropene of from 8 to 25% by weight, based on the total weight of the copolymer.

5. A process as claimed in any one of claims 1 to 4, where the composite article has the following structure:
collector negative electrode
a negative-electrode layer C,
a separator layer B,
a positive-electrode layer D, and
collector positive electrode.

6. A process as claimed in claim 5, where the separator layer B, the negative-electrode layer C and the positive-electrode layer D each comprise a random copolymer of vinylidene fluoride and hexafluoropropene having a content of hexafluoropropene of from 8 to 25% by weight, based on the total weight of the copolymer.

7. The use of a composite article produced by means of a process as claimed in any one of claims 1 to 6 for the production of an electrochemical cell, in a sensor, an electrochromic window, a display, a capacitor or an ion-conducting film.

8. An electrochemical cell comprising a composite article produced by means of a process as claimed in any one of claims 1 to 6.

9. The use of an electrochemical cell as claimed in claim 8 as an automotive battery, portable battery, flat battery, on-board battery, battery for static applications, battery for electric traction or polymer battery.

10. A process for the production of a composite article comprising
A) at least one substrate film A and, applied thereto,
B) at least one separator layer B which comprises a mixture I comprising a mixture II consisting of
a) from 1 to 95% by weight of a solid II, preferably a basic solid III, having a primary particle size of from 5 nm to 20 μm, and
b) from 5 to 99% by weight of a polymeric composition IV obtainable by polymerization of
b1) from 5 to 100% by weight, based on the composition IV, of a condensation product V of
α) at least one compound VI which is capable of reacting with a carboxylic acid or a sulfonic acid or a derivative or a mixture of two or more thereof, and
β) at least 1 mol per mole of the compound VI, of a carboxylic acid or sulfonic acid VII containing at least one free-radical-polymerizable functional group, or of a derivative thereof or of a mixture of two or more thereof, and
b2) from 0 to 95% by weight, based on the composition IV, of a further compound VIII having a mean molecular weight (number average) of at least 5000 containing polyether segments in the main or side chain,
where the proportion by weight of the mixture II in the mixture I is from 1 to 100% by weight, or
a polymer or copolymer of vinyl chloride, acrylonitrile, vinylidene fluoride, vinyl chloride with vinylidene chloride, vinyl chloride with acrylonitrile, vinylidene chloride with hexafluoropropylene, vinylidene fluoride with hexafluoropropylene and a member selected from the group consisting of vinyl fluoride, tetrafluoroethylene and a trifluoroethylene,
and where the layer comprises no electron-conducting, electrochemically active compound, and
C) at least one negative-electrode layer C which comprises and electron-conducting, electrochemically active compound which is capable of releasing lithium ions during charging or
D) at least one positive-electrode layer D which comprises and electron-conducting, electrochemical compound which is capable of taking up lithium ions during charging, or
at least one negative-electrode layer C and at least one positive-electrode layer D,
wherein the at least one separator layer B and the at least one negative-electrode layer C or the at least one positive-electrode layer D or the at least one negative-electrode layer C and the at least one positive-electrode layer D are brought into contact with one another by a wet-on-wet coating process.

11. A process as claimed in claim 10, where the composite article furthermore comprises at least one adhesion-promoting layer E.

12. A process as claimed in claim 10, where the at least one substrate film A is a film-form collector electrode.

13. A process as claimed in claim 11, where the at least one substrate film A is a film-form collector electrode.

14. A process as claimed in claim 10, where the at least one separator layer B comprises a random copolymer of vinylidene fluoride and hexafluoropropene having a content of hexafluoropropene of from 8 to 25% by weight, based on the total weight of the copolymer.

15. A process as claimed in claim 11, where the at least one separator layer B comprises a random copolymer of vinylidene fluoride and hexafluoropropene having a content of hexafluoropropene of from 8 to 25% by weight, based on the total weight of the copolymer.

16. A process as claimed in claim 10, where the composite article has the following structure:
collector negative electrode
a negative-electrode layer C,
a separator layer B,
a positive-electrode layer D, and
collector positive electrode.

17. A process as claimed in claim 11, where the composite article has the following structure:
collector negative electrode
a negative-electrode layer C,
a separator layer B,
a positive-electrode layer D, and
collector positive electrode.

18. A process as claimed in claim 16, where the separator layer B, the negative-electrode layer C and the positive-electrode layer D each comprise a random copolymer of vinylidene fluoride and hexafluoropropene having a content of hexafluoropropene of from 8 to 25% by weight, based on the total weight of the copolymer.

19. A process as claimed in claim 17, where the separator layer B, the negative-electrode layer C and the positive electrode layer D each comprise a random copolymer of vinylidene fluoride and hexafluoropropene having a content of hexafluoropropene of from 8 to 25% by weight, based on the total weight of the copolymer.

20. The method of using a composite article produced by means of a process as claimed in claim 10 for the production of an electrochemical cell, a sensor, an electrochromic window, a display, a capacitor or an ion-conducting film.

21. The method of using a composite article produced by means of a process as claimed in claim 11 for the production of an electrochemical cell, a sensor, an electrochromic window, a display, a capacitor or an ion-conducting film.

22. An electrochemical cell comprising a composite article produced by means of a process as claimed in claim 10.

23. An electrochemical cell comprising a composite article produced by means of a process as claimed in claim 11.

24. The method of using an electrochemical cell as claimed in claim 22 as an automotive battery, portable battery, flat battery, on-board battery, battery for static applications, batter for electric traction or polymer battery.

25. The method of using an electrochemical cell as claimed in claim 23 as an automotive battery, portable battery, flat battery, on-board battery, battery for static applications, battery for electric traction or polymer battery.
